(19) United States
(12) Patent Application Publication
(10) Pub. No.: US 2026/0202554 A1
(43) Pub. Date: Jul. 16, 2026

(54) INFORMATION PROCESSING APPARATUS, INFORMATION PROCESSING METHOD, AND COMPUTER-READABLE RECORDING MEDIUM

(71) Applicant: NEC Solution Innovators, Ltd., Tokyo (JP)

(72) Inventor: Yoshihiro YAMASHITA, Tokyo (JP)

(73) Assignee: NEC Solution Innovators, Ltd., Tokyo (JP)

(21) Appl. No.: 19/135,968

(22) PCT Filed: Oct. 19, 2023
(86) PCT No.: PCT/JP2023/037927

§ 371 Date: Jun. 5, 2025

(30) Foreign Application Priority Data
Dec. 13, 2022 (JP) 2022-198640

(51) Int. Cl. G01S 19/43; G06T 7/70; G06V 20/13

(52) U.S. Cl. CPC G01S 19/43; G06T 7/70; G06V 20/13

(57) ABSTRACT

An information processing apparatus adds time information indicating an imaging time to each frame; acquires, in time-series, first positioning data received by a moving body that captures the moving image data from each positioning satellite, and second positioning data received by a base station installed at a fixed point from each positioning satellite; calculates, in time-series, a position of the moving body, based on a relative relationship between the first positioning data and the second positioning data and a position of the fixed point; collates, for each of the frames, the imaging time indicated by the time information added to the frame with a time associated with the first positioning data, and specifies a position corresponding to an imaging position of the frame from among positions of the moving body calculated in time-series; and adds, for each of the frames, information indicating the specified position to the frame.

### TECHNICAL FIELD

The present disclosure relates to an information processing apparatus and an information processing method for processing moving image data, and further relates to a computer-readable recording medium in which a program for realizing the apparatus and the method is recorded.

### BACKGROUND ART

Conventionally, a technique has been proposed in which a set of feature points corresponding to each other between images are extracted from a plurality of still images acquired by imaging a target from different angles, and three dimensional point cloud data of the target is created with use of the extracted set of feature points. In addition, a technique has also been proposed in which three dimensional point cloud data of a target is created with use of a moving image instead of a plurality of still images.

In the latter technique using a moving image, it is not necessary to perform imaging many times as in the former technique using still images, and it is only necessary to capture a moving image of the entire target. Therefore, the latter technique using a moving image is useful in a case of creating three dimensional point cloud data of a structure having a large and complicated shape, such as a plant or a bridge.

Incidentally, when three dimensional point cloud data is created from a moving image, since moving image is captured while moving, the imaging position changes for each frame. Therefore, in order to extract a set of feature points corresponding to each other between the frames, it is necessary to specify an imaging position for each frame.

For example, Patent Document 1 discloses an apparatus that specifies the position of a moving body that captures a moving image. The apparatus disclosed in Patent Document 1 obtains the position of a moving body equipped with a camera by a global positioning system (GPS) receiver, compares the imaging time of each frame with a positioning time, and specifies a position for each frame based on the comparison result.

### LIST OF RELATED ART DOCUMENTS

### Patent Document

Patent Document 1: Japanese Patent Laid-Open Publication No. 2006-250917

### SUMMARY OF INVENTION

### Problems to be Solved by the Invention

However, in the apparatus disclosed in Patent Document 1, since the position of the moving body is specified by general GPS positioning, there is a problem that the accuracy of the specified position is low. This will be specifically described below.

First, in general GPS positioning, a single GPS receiver receives radio signals from three positioning satellites. Since each received radio signal includes a transmission time added thereto by the corresponding positioning satellite, the GPS receiver acquires the difference between the reception time, which is the time when the GPS receiver received the radio signal, and the transmission time for the corresponding positioning satellite, and calculates the distance to the positioning satellite based on the difference. Thereafter, the GPS receiver calculates its own position from the positions of the positioning satellites and the distances to the positioning satellites.

At this time, the accuracy of the time measurement in the GPS receiver is lower than the accuracy of the time added to the radio signal by the positioning satellite, and an error occurs in the reception time. In addition, when the GPS receiver receives a radio signal reflected by an obstacle, this also causes an error in the reception time. In such a situation, an error also occurs in the distances to the positioning satellites calculated by the GPS receiver, and as a result, the apparatus disclosed in Patent Document 1 has a problem that the accuracy of the specified position is low.

An example object of the present disclosure is to improve accuracy of position information in a case where position information of an imaging position is added to moving image data.

### Means for Solving the Problems

In order to achieve the above-described object, an information processing apparatus according to an example aspect of the present disclosure includes:
a time information addition unit that adds time information indicating an imaging time to each frame constituting moving image data;
a data acquisition unit that acquires, in time-series, first positioning data received by a moving body that captures the moving image data from each of a plurality of positioning satellites, and second positioning data received by a base station installed at a fixed point from each of the plurality of positioning satellites;
a position calculation unit that calculates, in time-series, a position of the moving body, based on a relative relationship between the first positioning data and the second positioning data for each positioning satellite and a position of the fixed point at which the base station is installed;
an imaging position specification unit that collates, for each of the frames, the imaging time indicated by the time information added to the frame with a time associated with the first positioning data, and specifies a position corresponding to an imaging position of the frame from among positions of the moving body calculated in time-series; and
a position information addition unit that adds, for each of the frames, information indicating the specified position to the frame.

In order to achieve the above-described object, an information processing method according to an example aspect of the present disclosure includes:
a time information addition step of adding time information indicating an imaging time to each frame constituting moving image data;
a data acquisition step of acquiring, in time-series, first positioning data received by a moving body that captures the moving image data from each of a plurality of positioning satellites, and second positioning data received by a base station installed at a fixed point from each of the plurality of positioning satellites;
a position calculation step of calculating, in time-series, a position of the moving body, based on a relative relationship between the first positioning data and the second positioning data for each positioning satellite and a position of the fixed point at which the base station is installed;
an imaging position specification step of specifying, for each of the frames, collating the imaging time indicated by the time information added to the frame with a time associated with the first positioning data, and specifying a position corresponding to an imaging position of the frame from among positions of the moving body calculated in time-series; and
a position information addition step of adding, for each of the frames, information indicating the specified position to the frame.

In order to achieve the above-described object, a computer readable recording medium according to an example aspect of the present disclosure is a computer readable recording medium that includes recorded thereon a program,
the program including instruction that cause a computer to carry out:
a time information addition step of adding time information indicating an imaging time to each frame constituting moving image data;
a data acquisition step of acquiring, in time-series, first positioning data received by a moving body that captures the moving image data from each of a plurality of positioning satellites, and second positioning data received by a base station installed at a fixed point from each of the plurality of positioning satellites;
a position calculation step of calculating, in time-series, a position of the moving body, based on a relative relationship between the first positioning data and the second positioning data for each positioning satellite and a position of the fixed point at which the base station is installed;
an imaging position specification step of specifying, for each of the frames, collating the imaging time indicated by the time information added to the frame with a time associated with the first positioning data, and specifying a position corresponding to an imaging position of the frame from among positions of the moving body calculated in time-series; and
a position information addition step of adding, for each of the frames, information indicating the specified position to the frame.

### Advantageous Effects of the Invention

As described above, according to the present disclosure, it is possible to improve accuracy of position information in a case where position information of an imaging position is added to moving image data.

### BRIEF DESCRIPTION OF THE DRAWINGS

FIG. 1 is a configuration diagram illustrating a schematic configuration of an information processing apparatus according to an example embodiment.

FIG. 2 is a configuration diagram illustrating the information processing apparatus and peripheral devices thereof according to the example embodiment.

FIG. 3 is a diagram illustrating an example of processing performed by a time information addition unit according to the example embodiment.

FIG. 4 is a diagram illustrating an example of processing performed by an imaging position specifying unit according to the example embodiment.

FIG. 5 is a flowchart illustrating operations performed by the information processing apparatus according to the example embodiment.

FIG. 6 is a block diagram illustrating an example of a computer that realizes the information processing apparatus according to the example embodiment.

### EXAMPLE EMBODIMENT

### Example Embodiment

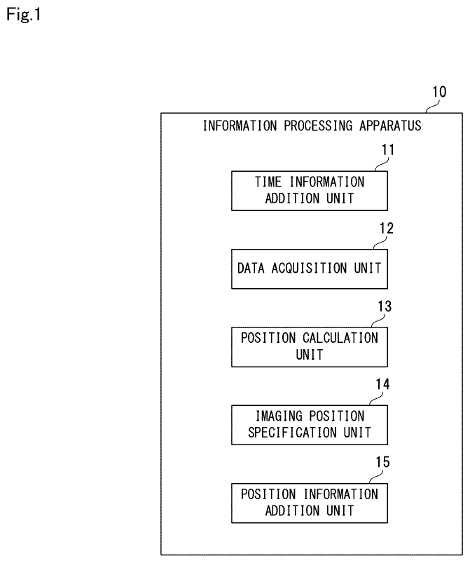

Hereinafter, an information processing apparatus, an information processing method, and a program according to an example embodiment will be described with reference to FIGS. 1 to 6.

### [Apparatus Configuration]

First, a schematic configuration of an information processing apparatus according to an example embodiment will be described with reference to FIG. 1. FIG. 1 is a configuration diagram illustrating a schematic configuration of an information processing apparatus according to an example embodiment.

An information processing apparatus 10 according to the example embodiment illustrated in FIG. 1 is a data creation assistance apparatus for assisting creation of three dimensional point cloud data from moving image data. As illustrated in FIG. 1, the information processing apparatus 10 includes a time information addition unit 11, a data acquisition unit 12, a position calculation unit 13, an imaging position specification unit 14, and a position information addition unit 15.

The time information addition unit 11 adds time information indicating an imaging time to each frame constituting the moving image data. Here, the time information is not limited to information indicating the absolute time of the imaging time point, and may be information indicating a relative time using the start time of the first frame of the moving image as zero.

The data acquisition unit 12 acquires first positioning data and second positioning data in time-series. The first positioning data is positioning data received from each of a plurality of positioning satellites by a moving body that captures moving image data. The second positioning data is positioning data received by a base station installed at a fixed point from each of the plurality of positioning satellites.

The position calculation unit 13 calculates the position of the moving body in time-series, based on the relative relationship between the first positioning data and the second positioning data for each positioning satellite and the position of the fixed point at which the base station is installed.

For each frame constituting the moving image data, the imaging position specification unit 14 collates the imaging time indicated by the time information added to the frame with the time associated with the first positioning data. Then, the imaging position specification unit 14 specifies the position corresponding to the imaging position of the frame from among the positions of the moving body calculated in time-series on the basis of the collation result. The position information addition unit 15 adds information indicating the specified position to each frame.

However, in general, the frame interval of the moving image data is shorter than the transmission interval of the positioning data transmitted by the satellites. Therefore, the imaging position specification unit 14 does not need to collate the transmission time for all the frames. In this case, the imaging position specification unit 14 may execute the collation only for the frame corresponding to the transmission time of the first positioning data, for example, for one frame for every specific number of frames.

As described above, in the example embodiment, the information processing apparatus specifies the position by using not only the positioning data received by the moving body alone but rather the positioning data received by both the moving body and the base station. Therefore, according to the information processing apparatus 10, it is possible to improve the accuracy of the position information in a case where the position information of the imaging position is added to the moving image data.

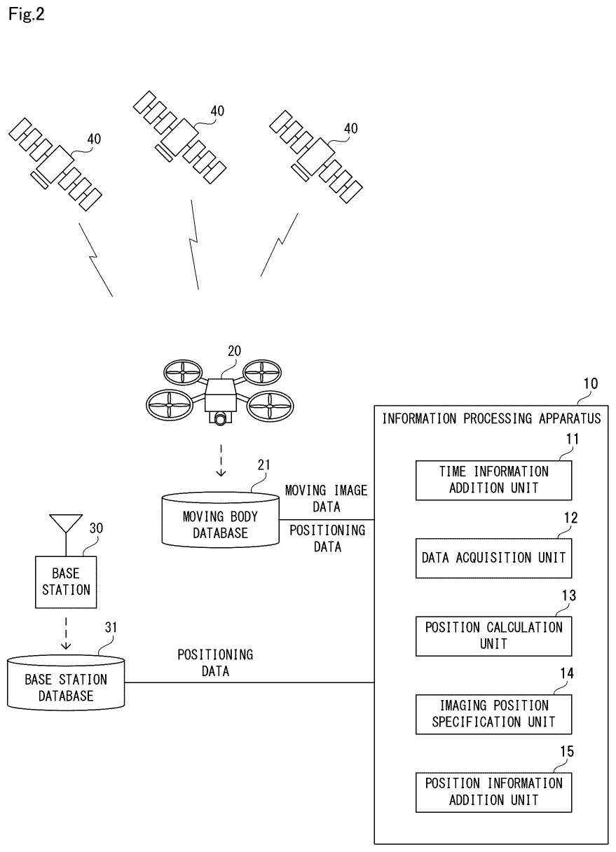

Next, a configuration and functions of the information processing apparatus according to the example embodiment will be specifically described with reference to FIGS. 2 to 4. FIG. 2 is a configuration diagram illustrating the information processing apparatus and peripheral devices thereof according to the example embodiment.

As illustrated in FIG. 2, in the example embodiment, the moving body that captures moving image data is an unmanned aerial vehicle 20 equipped with a camera. The unmanned aerial vehicle 20 is equipped with a global navigation satellite system (GNSS) receiver, and receives positioning data (first positioning data) from each of the positioning satellites 40. The moving image data captured by the unmanned aerial vehicle 20 is accumulated in a moving body database 21. Further, the first positioning data received by the GNSS receiver of the unmanned aerial vehicle 20 is accumulated in the moving body database 21.

A base station 30 also includes a GNSS receiver, and receives positioning data (second positioning data) from each of the positioning satellites 40 by the GNSS receiver. The second positioning data received by the base station 30 is accumulated in a base station database 31. The base station 30 also receives, from each of the positioning satellites, satellite orbit data indicating the position of the positioning satellite for each time. The base station database 31 also accumulates satellite orbit data.

Further, each positioning satellite 40 transmits the positioning data at a constant frequency, and the first positioning data and the second positioning data are received at a set interval. Therefore, the moving body database 21 accumulates the first positioning data for each positioning satellite in time-series. The base station database 31 accumulates second positioning data (carrier phase data and route data) and satellite orbit data for each positioning satellite in time-series.

In the example embodiment, the data acquisition unit 12 acquires the accumulated first positioning data and moving image data from the moving body database 21. Further, the data acquisition unit 12 acquires the accumulated second positioning data and satellite orbit data from the base station database 31. The data acquisition unit 12 passes the acquired moving image data to the time information addition unit 11, and passes the acquired first positioning data and second positioning data to the position calculation unit 13.

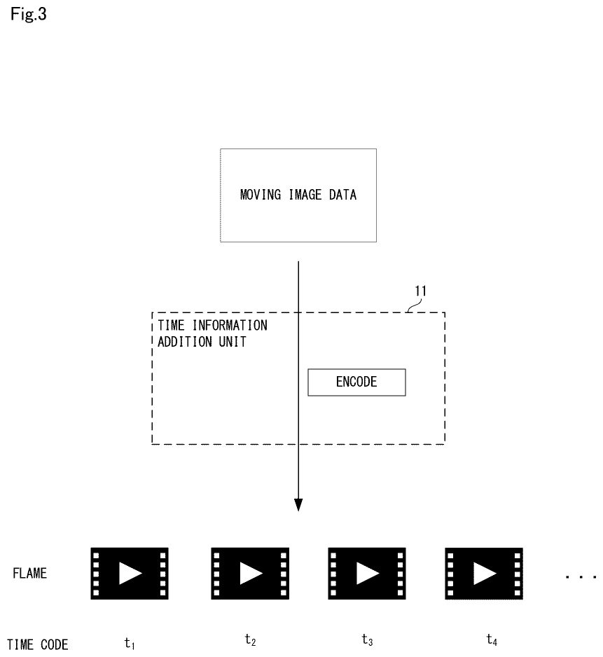

In the example embodiment, the time information addition unit 11 receives moving image data captured by the unmanned aerial vehicle 20 from the data acquisition unit 12, and encodes the acquired moving image data. When the encoding is executed, as illustrated in FIG. 3, time information indicating the imaging time is embedded as a time code in each of the frames constituting the moving image data. FIG. 3 is a diagram illustrating an example of processing performed by a time information addition unit according to the example embodiment.

When it is difficult to transmit the moving image data from the unmanned aerial vehicle 20 to the time information addition unit 11 due to a problem related to the transmission band, for example, the time information addition unit 11 may be mounted in the unmanned aerial vehicle 20. In this case, in the unmanned aerial vehicle 20, the time information addition unit 11 executes encoding and embedding of a time code.

In the example embodiment, the position calculation unit 13 creates first observation data from the first positioning data and creates the second observation data from the second positioning data. Each of the first observation data and the second observation data described above is data including a pseudo range and a carrier phase from the GNSS receiver to each positioning satellite 40. Then, the position calculation unit 13 acquires the relative relationship between the first positioning data and the second positioning data for each positioning satellite in time-series using the first observation data, the second observation data, and the satellite orbit data, and calculates the position of the moving body (the unmanned aerial vehicle 20) based on the acquired relative relationship and the position of the fixed point.

Here, the position calculation processing of the unmanned aerial vehicle 20 by the position calculation unit 13 will be specifically described in detail below. In the following description, the following documents are referred to as appropriate. “A.4 RTK-GPS and Network-Type RTK-GPS Positioning Technology” written by Takasu Tomoji (Tokyo University of Marine Science and Technology)<https://gpspp.sakura.ne.jp/paper2005/gpssymp_2007a.pdf>

First, as described above, the observation data is data including a pseudo range and a carrier phase. Here, as illustrated in the above document, the pseudo range is defined as a value acquired by multiplying a signal propagation time measured by a positioning code (RPN code) by the speed of light.

The carrier phase is determined from the difference between the phase of the received carrier and the phase of the reference oscillator of the GNSS receiver. According to the carrier phase, it is possible to know the wave number of the radio signal received from the positioning satellite at the time of arrival from the phase when the radio signal is transmitted from the positioning satellite, so that the distance from the positioning satellite 40 is calculated by multiplying the wave number by the wavelength.

A pseudo range (observation value) P and a carrier phase (observation value) φ of a positioning satellite s received by a GNSS receiver r are expressed by an observation equation illustrated in the following Expression 1. In Expression 1 below, ρ denotes the geometric distance [m] between the positioning satellite and the receiver, and c denotes the speed of light [m/s]. The geometric distance ρ is acquired from the satellite orbit data. dt denotes a time error [s] of the GNSS receiver, and dT denotes a clock error [s] of the positioning satellite. I denotes the ionospheric delay [m]), T denotes the tropospheric delay [m], λ denotes the carrier wavelength [m], ε denotes the observation error [m], and N denotes the carrier phase bias [number of cycles].

$${P}_{r}^{s} = {ρ}_{r}^{s} + c ( {dt}_{r} - {dT}^{s} ) + {I}_{r}^{s} + {T}_{r}^{s} + {ε}_{P} \qquad [ Expression 1 ]$$

$${Φ}_{r}^{s} = {ρ}_{r}^{s} + c ( {dt}_{r} - {dT}^{s} ) - {I}_{r}^{s} + {T}_{r}^{s} + λ {N}_{r}^{s} + {ε}_{Φ}$$

In addition, when the double difference (double phase difference) of the carrier phase is acquired in the observation equation of the relative positioning in the above Expression 1, the initial phase term is erased and the carrier phase bias N becomes an integer. Hereinafter, the carrier phase bias N is also particularly denoted as an “integer ambiguity N”.

Here, in the two receivers, namely, a GNSS receiver u (base station 30) and the GNSS receiver r (unmanned aerial vehicle 20), the carrier phases of positioning satellites a and b measured substantially at the same time are denoted by φᵤ^{a}, φᵤ^{b}, φᵣ^{a}, and φᵣ^{b}, and the pseudo ranges are denoted by pᵤ^{a}, pᵤ^{b}, pᵣ^{a}, and pᵣ^{b}. Here, the superscript indicates the positioning satellite 40, and the subscript indicates the GNN receiver (observation point). The carrier phase double difference φᵤᵣ^{ab} and the pseudo range double difference pᵤᵣ^{ab} are defined by the following Expression 2.

$${Φ}_{ur}^{ab} = ( {Φ}_{u}^{a} - {Φ}_{u}^{b} ) - ( {Φ}_{t}^{a} - {Φ}_{r}^{b} ) \qquad [ Expression 2 ]$$

$${p}_{ur}^{ab} = ( {p}_{u}^{a} - {p}_{u}^{b} ) - ( {p}_{r}^{a} - {p}_{r}^{b} )$$

Further, the above Expression 2 can be modified as the following Expression 3.

$${Φ}_{ur}^{ab} = ( {Φ}_{u}^{a} - {Φ}_{r}^{a} ) - ( {Φ}_{u}^{b} - {Φ}_{r}^{b} ) \qquad [ Expression 3 ]$$

$${p}_{ur}^{ab} = ( {p}_{u}^{a} - {p}_{r}^{a} ) - ( {p}_{u}^{b} - {p}_{r}^{b} )$$

Here, the carrier phase double difference φᵤᵣ^{ab} and the pseudo range double difference pᵤᵣ^{ab} are as represented by the following Expression 4 using the notation of the above Expression 1.

$${Φ}_{u r}^{a b} = {ρ}_{u r}^{a b} + c ( d {t}_{ur}^{a b} - d {T}_{ur}^{a b} ) - {I}_{u r}^{α b} + {T}_{ur}^{a b} + λ {N}_{u r}^{a b} + {ε}_{Φ u r}^{a b} \qquad [ Expression 4 ]$$

$${P}_{ι ι r}^{ab} = {ρ}_{ur}^{ab} + c ( d {t}_{ur}^{ab} - d {T}_{ur}^{ab} ) + {I}_{ur}^{ab} + {T}_{ur}^{a b} + {ε}_{P u r}^{a b}$$

In addition, in each GNSS receiver, considering that the positioning data of each positioning satellite 40 is received at the same time, a relationship represented by the following Expression 5 is established.

$$d {t}_{ur}^{a b} = ( d {t}_{u}^{a} - d {t}_{u}^{b} ) - ( d {t}_{r}^{a} - d {t}_{r}^{b} ) = 0 \qquad [ Expression 5 ]$$

Further, in each positioning satellite 40, when it is considered that the transmission time of the positioning data is substantially the same and the positioning satellite clock is sufficiently stable within a short time, the following Expression 6 is also established.

$$d {T}_{u r}^{α b} = ( d {T}_{u}^{a} - d {T}_{u}^{b} ) - ( d {T}_{r}^{a} - d {T}_{r}^{b} ) \approx 0 \qquad [ Expression 6 ]$$

By applying the above Expressions 5 and 6 to the above-described Expression 4, the observation equations of the carrier phase and the pseudo range double difference become as illustrated in the following Expression 7. In the following Expression 7, the terms of the positioning satellite clock error and the receiver clock error are deleted from the carrier phase double difference.

$${Φ}_{u r}^{c ι b} = {ρ}_{u r}^{a b} - {I}_{u r}^{a b} + {T}_{u r}^{a b} + λ {N}_{u r}^{ab} + {ε}_{Φ u r}^{a b} \qquad [ Expression 7 ]$$

$${P}_{ur}^{a b} = {ρ}_{u r}^{ab} + {I}_{u r}^{a b} + {T}_{ur}^{ab} + {ε}_{Pur}^{a b}$$

Here, it is assumed that the distance between the GNSS receiver u (base station 30) and the GNSS receiver r (unmanned aerial vehicle 20) (i.e., the u-r baseline length) is sufficiently short. When the positioning data from the same positioning satellite 40 is received at the same time at two points sufficiently close to each other, the propagation path of the positioning signal (the signal of the positioning data) in the atmosphere, the ionosphere at each point, and the tropospheric delay at each point are substantially the same. For this reason, approximation illustrated in the following Expression 8 is possible.

$${I}_{u r}^{ab} = ( {I}_{u}^{a} - {I}_{u}^{b} ) - ( {I}_{r}^{a} - {I}_{r}^{b} ) \approx 0 \qquad [ Expression 8 ]$$

$${T}_{ur}^{a b} = ( {T}_{u}^{a} - {T}_{u}^{b} ) - ( {T}_{r}^{a} - {T}_{r}^{b} ) \approx 0$$

When Expression 8 is applied to Expression 7, the observation equation of the carrier phase and the pseudo range double difference can be approximated as represented by the following Expression 9.

$${Φ}_{u r}^{a b} = {ρ}_{u r}^{ab} + λ {N}_{u r}^{a b} + {ε}_{Φ u r}^{a b} \qquad [ Expression 9 ]$$

$${P}_{u r}^{ab} = {ρ}_{u r}^{a b} + {ε}_{Pur}^{a b}$$

Here, the position of the GNSS receiver r (unmanned aerial vehicle 20) is denoted by rᵤ, and the inter-receiver single difference integer ambiguity of the received carrier wave Li is denoted by Nᵢ. Then, the estimation parameter x is expressed by the following Expression 10, and the double difference observation amount vector y is represented by the following Expression 11.

$$x = {( {r}_{u}^{T} {N}_{1}^{T} {N}_{2}^{T} )}^{T} \qquad [ Expression 10 ]$$

$${N}_{i} = {( {N}_{uri}^{1} {N}_{u r i}^{2} {N}_{uri}^{3} … {N}_{uri}^{n} )}^{T}$$

$$y = {( {Φ}_{1}^{T} {Φ}_{2}^{T} {P}_{1}^{T} {P}_{2}^{T} )}^{T} \qquad [ Expression 11 ]$$

$${Φ}_{i} = {( {Φ}_{uri}^{12} {Φ}_{uri}^{13} {Φ}_{u r i}^{14} … {Φ}_{u r i}^{1 n} )}^{T}$$

$${P}_{i} = {( {P}_{uri}^{12} {P}_{uri}^{13} {P}_{uri}^{14} … {P}_{uri}^{1 n} )}^{T}$$

Expressions 10 and 11 are applied to Expression 9. Accordingly, the observation equation and the partial differential coefficient matrix of the double difference observation amount vector y are represented as follows.

$$\begin{matrix}Observation equation & \\ y = h ( x ) + ε & [ Expression 12 ]\end{matrix}$$

$$h ( x ) = {( {{h}_{Φ 1} ( x )}^{T} {{h}_{Φ 2} ( x )}^{T} {{h}_{P 1} ( x )}^{T} {{h}_{P 2} ( x )}^{T} )}^{T}$$

$${h}_{Φ i} ( x ) = ( \begin{matrix}{ρ}_{ur}^{12} + {λ}_{i} ( {N}_{uri}^{1} - {N}_{uri}^{2} ) \\ {ρ}_{ur}^{12} + {λ}_{i} ( {N}_{uri}^{1} - {N}_{uri}^{3} ) \\ ⋮ \\ {ρ}_{ur}^{12} + {λ}_{i} ( {N}_{uri}^{1} - {N}_{uri}^{n} )\end{matrix} ) , {h}_{Pi} ( x ) = ( \begin{matrix}{ρ}_{ur}^{12} \\ {ρ}_{ur}^{12} \\ ⋮ \\ {ρ}_{ur}^{12}\end{matrix} )$$

$$\begin{matrix}Partial differential coefficient matrix & \\ H ( x ) = \frac{\partial y}{\partial x} = [ \begin{matrix}- L & {Λ}_{1} & 0 \\ - L & 0 & {Λ}_{2} \\ - L & 0 & 0 \\ - L & 0 & 0\end{matrix} ] & [ Expression 13 ]\end{matrix}$$

$$L = {( {( {e}_{u r}^{12} )}^{T} {( {e}_{u r}^{13} )}^{T} {( {e}_{u γ}^{14} )}^{T} … {( {e}_{u r}^{1 n} )}^{T} )}^{T}$$

$${Λ}_{i} = ( \begin{matrix}{λ}_{i} & - {λ}_{i} & 0 & 0 & 0 & 0 \\ {λ}_{i} & 0 & - {λ}_{i} & 0 & 0 & 0 \\ {λ}_{i} & 0 & 0 & - {λ}_{i} & 0 & 0 \\ ⋮ & & & & ⋱ & ⋮ \\ {λ}_{i} & 0 & 0 & 0 & … & - {λ}_{i}\end{matrix} )$$

e denotes a directional unit vector from the GNSS receiver to the positioning satellite

The observation error covariance matrix R of the double difference observation amount is as represented by the following Expression 14.

$$R = E ( {εε}^{T} ) = ( \begin{matrix}{R}_{Φ 1} & & & \\ & {R}_{Φ 2} & & \\ & & {R}_{P 1} & \\ & & & {R}_{P 2}\end{matrix} ) \qquad [ Expression 14 ]$$

$${R}_{Φ i} = ( \begin{matrix}4 {σ}_{Φ}^{2} & 2 {σ}_{Φ}^{2} & … & 2 {σ}_{Φ}^{2} \\ 2 {σ}_{Φ}^{2} & 4 {σ}_{Φ}^{2} & … & 2 {σ}_{Φ}^{2} \\ ⋮ & ⋮ & ⋱ & ⋮ \\ 2 {σ}_{Φ}^{2} & 2 {σ}_{Φ}^{2} & … & 4 {σ}_{Φ}^{2}\end{matrix} ) ( {ε}_{Φ} \sim N ( 0 , {σ}_{Φ}^{2} ) )$$

$${R}_{Pi} = ( \begin{matrix}4 {σ}_{P}^{2} & 2 {σ}_{P}^{2} & … & 2 {σ}_{P}^{2} \\ 2 {σ}_{P}^{2} & 4 {σ}_{P}^{2} & … & 2 {σ}_{P}^{2} \\ ⋮ & ⋮ & ⋱ & ⋮ \\ 2 {σ}_{P}^{2} & 2 {σ}_{P}^{2} & … & 4 {σ}_{P}^{2}\end{matrix} ) ( {ε}_{P} \sim N ( 0 , {σ}_{P}^{2} ) )$$

The position calculation unit 13 acquires an estimated value xₖ hat of an unknown parameter x of each GNSS receiver by the extended Kalman filter using the observation equation described above. The equations for correction and update by the extended Kalman filter in each GNSS receiver k are represented as follows using the above Expressions 12 to 14.

$${\hat{x}}_{k}^{+} = {\hat{x}}_{k}^{-} + {K}_{k} ( {y}_{k} - {h}_{k} ( {\hat{x}}_{k}^{-} ) ) \qquad [ Expression 15 ]$$

$${P}_{k}^{+} = ( I - {K}_{k} {H}_{k} ( {\hat{x}}_{k}^{-} ) ) {P}_{k}^{-}$$

$${K}_{k} = {P}_{k}^{-} {H}_{k}^{T} ( {\hat{x}}_{k}^{-} ) {( {H}_{k} ( {\hat{x}}_{k}^{-} ) {P}_{k}^{-} {H}_{k}^{T} ( {\hat{x}}_{k}^{-} ) + {R}_{k} )}^{- 1}$$

In the above Expression 15, xₖ hat denotes an a-priori estimation vector of the unknown parameter x in the GNSS receiver k. xₖ⁺ hat denotes an a-posteriori estimation vector of the unknown parameter x at the GNSS receiver k. Pₖ⁻ denotes the a-priori error covariance matrix at the GNSS receiver k. Pₖ⁺ denotes the a-posteriori error covariance matrix at GNSS receiver k. Kₖ denotes the Kalman gain matrix at the GNSS receiver k. I denotes the identity matrix.

Then, according to the extended Kalman filter, the position, the integer ambiguity estimation value x hat, and the covariance matrix P of each GNSS receiver can be acquired. Also, the integer ambiguity acquired here is a real estimate that does not take into account the integer condition constraint, and the estimate of the position of the GNSS receiver acquired at the same time is referred to as a FLOAT solution. Since the GNSS receiver u (base station 30) is fixed, its position is known in advance. Therefore, only the position of the GNSS receiver r (unmanned aerial vehicle 20) is estimated by the FLOAT solution.

The position calculation unit 13 calculates an integer solution of the integer ambiguity by using the integer least-squares method with the FLOAT solution and the covariance matrix P as inputs, and calculates a final FIX solution. The FIX solution is the final position of the unmanned aerial vehicle 20.

Specifically, the single-difference integer ambiguity is converted to a double-difference integer bias estimate x′ hat as represented by the following Expression 16. In Expression 16 below, D is a conversion matrix for converting a single difference to a double difference.

$${\hat{x}}^{′} = {( {\hat{r}}_{U} {\hat{N}}_{ur 1}^{12} {\hat{N}}_{ur 1}^{13} … {\hat{N}}_{ur 1}^{1 n} {\hat{N}}_{ur 2}^{12} {\hat{N}}_{ur 2}^{13} … {\overline{N}}_{ur 2}^{1 n} )}^{T} = D \hat{x} \qquad [ Expression 16 ]$$

$$Q = {DPD}^{T}$$

$$D = ( \begin{matrix}{I}_{3 \times 3} & & \\ & {D}_{1} & \\ & & {D}_{2}\end{matrix} )$$

$${D}_{i} = ( \begin{matrix}1 & - 1 & 0 & … & 0 \\ 1 & 0 & - 1 & … & 0 \\ ⋮ & ⋮ & ⋮ & ⋱ & ⋮ \\ 1 & 0 & 0 & … & - 1\end{matrix} )$$

The above Expression 16 can be rewritten to the following Expression 17. In this manner, the double-difference integer ambiguity estimation value x′ and its covariance matrix Q are separated into real variables and integer variables.

$${\hat{x}}^{′} = {( \begin{matrix}{\hat{r}}_{u}^{T} & {\overline{N}}^{T}\end{matrix} )}^{T} \qquad [ Expression 17 ]$$

$$Q = ( \begin{matrix}{Q}_{r} & {Q}_{r N} \\ {Q}_{Nr} & {Q}_{N}\end{matrix} )$$

Here, the integer least squares method is applied. Then, the position calculation unit 13 sets, as the optimal integer solution N caron, the integer solution N that satisfies the condition of the following Expression 18 and is closest to the real solution N hat calculated at the distances r defined by the covariance matrix Q.

$$\check{N} = {arg min}_{N ∈ Z} {‖ \hat{N} - N ‖}_{{Q}_{N}}^{2} \qquad [ Expression 18 ]$$

Further, in the example embodiment, Least square Ambiguity Decorrelation Adjustment (LAMBDA) is used for the integer ambiguity search in the integer least squares method. In this case, the integer ambiguity candidate of the minimum residual value, the second integer ambiguity candidate, and the respective residual values searched by the LAMBDA method are used to perform the test by the Ratio test illustrated in the following Formula 19. Then, when the test result is greater than or equal to a threshold value (generally, 3 to 5), the test is regarded as passed, and the integer solution of the integer ambiguity is acquired.

$$\frac{{\vert Second residual minimum value \vert}^{2}}{{\vert Residual minimum value \vert}^{2}} \qquad [ Expression 19 ]$$

In addition, in a case where the integer solution of the integer ambiguity that has passed the test is acquired, the FIX solution rᵤ caron of the position of the GNSS receiver r of the unmanned aerial vehicle 20 is acquired on the basis of the following Expression 20 acquired by modifying Expressions 16 and 17.

$${\check{r}}_{u} = \hat{{r}_{u}} - {Q}_{Nr} {Q}_{r}^{- 1} ( \hat{N} - \check{N} ) \qquad [ Expression 20 ]$$

In the example embodiment, as described above, the position calculation unit 13 calculates the position of the unmanned aerial vehicle 20 using the positioning data accumulated in the database. Therefore, the position calculation unit 13 can also calculate the position of the unmanned aerial vehicle 20 in a forward direction from the past to the future, a reverse direction from the future to the past, or bi-directionally in the forward direction and the reverse direction. In particular, when the position of the unmanned aerial vehicle 20 is calculated bi-directionally in the forward direction and the reverse direction, the position calculation accuracy is further enhanced.

In the example embodiment, first, for each frame constituting the moving image data, the imaging position specification unit 14 collates the imaging time indicated by the time information added to the frame with the time associated with the first positioning data. Here, in the example embodiment, the time associated with the first positioning data is the time when the positioning satellite transmits the first positioning data, that is, the transmission time of the first positioning data.

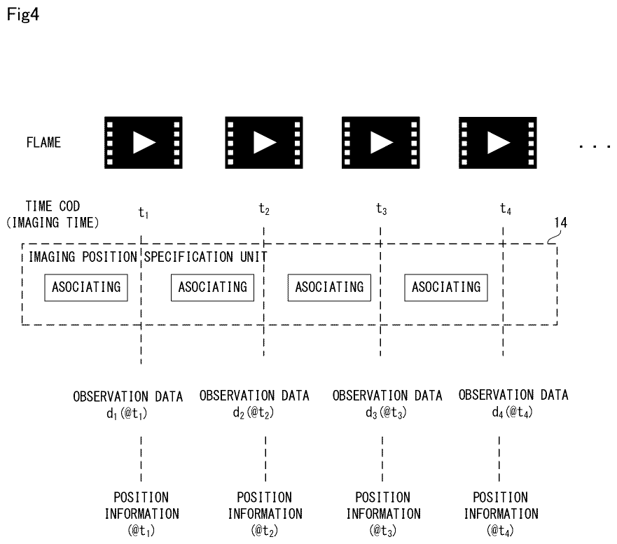

Then, as illustrated in FIG. 4, the imaging position specification unit 14 associates each frame with the first observation data created from the first positioning data such that the imaging time and the transmission time coincide with each other. In addition, since the position of the unmanned aerial vehicle 20 is calculated by the position calculation unit 13 for each piece of first observation data in which the imaging time and the transmission time coincide with each other, the position corresponding to the imaging position of each frame is specified by the association.

FIG. 4 is a diagram illustrating an example of processing performed by an imaging position specifying unit according to the example embodiment.

Further, in the example embodiment, it is preferable that the GNSS receiver of the unmanned aerial vehicle 20 and the GNSS receiver of the base station 30 receive the positioning data such that the imaging timing of each frame of the moving image data and the transmission time of the positioning data coincide with each other. In this case, the imaging time of each frame coincides with the transmission time (reception time) of the positioning data.

However, as described above, in general, the frame interval of the moving image data is shorter than the transmission interval when the satellite transmits the positioning data. Therefore, the imaging position specification unit 14 does not need to be able to collate the transmission time for all the frames. Specifically, in this case, the imaging position specification unit 14 skips a certain number of frames of the moving image data, and adjusts the frame interval at the time of encoding the moving image data so that the imaging timing of each specific frame and the transmission time of the positioning data coincide with each other.

In the above-described case, the calculation of the position by the position calculation unit 13 and the specification of the position by the imaging position specification unit 14 are executed using only the frame that matches the transmission timing of the positioning data. In this case, it is preferable that the imaging time and the transmission time of the matching frame (specific frame) coincide with each other, but the imaging time and the transmission time does not need to completely coincide with each other as long as a difference between the imaging time and the transmission time is within a set range.

Then, as illustrated in FIG. 4, the position information addition unit 15 specifies, for each specific frame, the position calculated by the position calculation unit 13 for the first observation data associated with the frame, and adds information indicating the specified position.

### [Apparatus Operations]

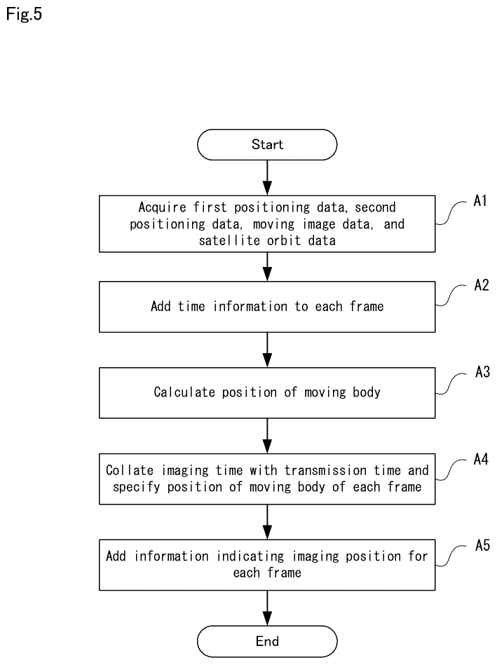

Next, operations of the information processing apparatus according to the example embodiment will be described using FIG. 5. FIG. 5 is a flowchart illustrating operations performed by the information processing apparatus according to the example embodiment. In the following description, FIGS. 1 to 4 will be referred to as appropriate. Also, in the example embodiment, an information processing method is implemented by operating the information processing apparatus 10. Therefore, the following description of operations of the information processing apparatus 10 substitutes for a description of the information processing method of the example embodiment.

As illustrated in FIG. 5, the data acquisition unit 12 first acquires the accumulated first positioning data and moving image data from the moving body database 21, and acquires the accumulated second positioning data and satellite orbit data from the base station database 31 (step A1).

Next, the time information addition unit 11 adds time information indicating an imaging time to each frame constituting the moving image data acquired in step A1 (step A2).

Specifically, in step A2, the time information addition unit 11 encodes the moving image data acquired in step A1. Thus, the time information indicating the imaging time is embedded as a time code in each of the frames constituting the moving image data (see FIG. 3).

Next, the position calculation unit 13 calculates the position of the unmanned aerial vehicle (moving body) 20 in time-series, based on the relative relationship between the first and second positioning data for each positioning satellite and the positions of the fixed points at which the base stations are installed (step A3).

Specifically, in step A3, the position calculation unit 13 creates the first observation data from the first positioning data, and creates the second observation data from the second positioning data. Then, the position calculation unit 13 uses the first and second observation data and the satellite orbit data acquired in step A1 to acquire the relative relationship between the first and second positioning data for each positioning satellite in time-series. Further, the position calculation unit 13 calculates the position of the unmanned aerial vehicle 20 based on the acquired relative relationship and the position of the base station 30 (fixed point).

Next, for each specific frame constituting the moving image data, the imaging position specification unit 14 collates the imaging time indicated by the time information added to the frame with the transmission time of the first positioning data. Then, the imaging position specification unit 14 specifies a position corresponding to the imaging position of each frame from among the positions of the moving body calculated in time-series on the basis of the collation result (step A4).

Specifically, in step A4, as illustrated in FIG. 4, the imaging position specification unit 14 associates each frame with the first observation date such that the imaging time and the transmission time coincide with each other or a difference between the imaging time and the transmission time is within a set range (see FIG. 4). By the association, a position corresponding to the imaging position of each frame is specified.

Next, the position information addition unit 15 specifies, for each specific frame, the position calculated in step A3 for the first observation date associated with the frame, and adds information indicating the specified position (step A5).

By executing steps A1 to A5, the position information of the imaging position is added to the specific frame. As a result, the three dimensional point cloud data of the target can be created using the image data of the frame associated with the information indicating the position and the associated position information.

As described above, the information processing apparatus 10 specifies the position by using not only the positioning data received by the moving body alone, but rather using the pieces of positioning data received by both the moving body and the base station. Therefore, with the information processing apparatus 10, it is possible to improve the accuracy of the position information in a case where the position information of the imaging position is added to the moving image data.

In addition, in the above-described example, the information processing apparatus 10 executes processing using data accumulated in time-series in advance as the moving image data, the first positioning data, the second positioning data, and the satellite orbit data, but the example embodiment is not limited to this example. When the moving image data, the first positioning data, the second positioning data, and the satellite orbit data are transmitted, the information processing apparatus 10 can also sequentially execute the processing in real time.

### [Program]

The program in the example embodiment need only be a program that causes a computer to execute steps A1 to A5 illustrated in FIG. 5. The information processing apparatus 10 and the information processing method can be realized, by this program being installed on a computer and executed. In this case, a processor of the computer performs processing while functioning as the time information addition unit 11, the data acquisition unit 12, the position calculation unit 13, the imaging position specification unit 14, and the position information addition unit 15. Examples of the computer include a smart phone and a tablet-type terminal device as well as a general-purpose PC.

The program in the example embodiment may also be executed by a computer system constructed from a plurality of computers. In this case, for example, each computer may function as one of the time information addition unit 11, the data acquisition unit 12, the position calculation unit 13, the imaging position specification unit 14, and the position information addition unit 15.

### [Variation]

Here, a variation of the example embodiment will be described. In the variation as well, the information processing apparatus 10 has the configuration illustrated in FIGS. 1 and 2. Similarly to the examples of FIGS. 1 and 2, in the variation as well, the information processing apparatus 10 includes the time information addition unit 11, the data acquisition unit 12, the position calculation unit 13, the imaging position specification unit 14, and the position information addition unit 15.

However, the variation is different from the above-described example in that the time associated with the first positioning data is the reception time of the first positioning data. Therefore, in the variation, for each frame constituting the moving image data, the imaging position specification unit 14 collates the imaging time indicated by the time information added to the frame with the reception time of the first positioning data.

The reception time is given to the first positioning data by, for example, the GNSS receiver of the unmanned aerial vehicle 20 which is a moving body. The method of assigning the reception time is not particularly limited. In the variation, in step A4 illustrated in FIG. 5, the reception time is used instead of the transmission time. However, as in the above-described example, steps A1 to A5 illustrated in FIG. 5 are also executed in the variation.

### [Physical Configuration]

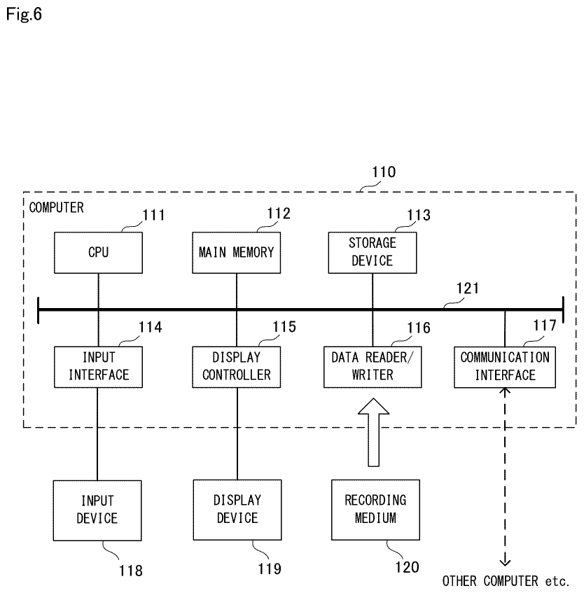

Using FIG. 6, the following describes a computer that realizes the information processing apparatus 10 by executing the program according to the example embodiment. FIG. 6 is a block diagram illustrating an example of a computer that realizes the information processing apparatus according to the example embodiment.

As illustrated in FIG. 6, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information processing apparatus 10 according to the example embodiment can also be realized by using items of hardware such as electronic circuit correspond to the components rather than the computer in which the program is installed. Furthermore, a part of the information processing apparatus 10 may be realized by the program, and the remaining part of the information processing apparatus 10 may be realized by hardware.

A part or an entirety of the above-described example embodiment can be represented by (Supplementary Note 1) to (Supplementary Note 18) described below but is not limited to the description below.

### (Supplementary Note 1)

An information processing apparatus includes:
a time information addition unit that adds time information indicating an imaging time to each frame constituting moving image data;
a data acquisition unit that acquires, in time-series, first positioning data received by a moving body that captures the moving image data from each of a plurality of positioning satellites, and second positioning data received by a base station installed at a fixed point from each of the plurality of positioning satellites;
a position calculation unit that calculates, in time-series, a position of the moving body, based on a relative relationship between the first positioning data and the second positioning data for each positioning satellite and a position of the fixed point at which the base station is installed;
an imaging position specification unit that collates, for each of the frames, the imaging time indicated by the time information added to the frame with a time associated with the first positioning data, and specifies a position corresponding to an imaging position of the frame from among positions of the moving body calculated in time-series; and
a position information addition unit that adds, for each of the frames, information indicating the specified position to the frame.

### (Supplementary Note 2)

The information processing apparatus according to claim 1,
wherein the data acquisition unit further acquires, for each of the plurality of positioning satellites, satellite orbit data indicating a position of the positioning satellite for each time received by the base station from the positioning satellite,
the position calculation unit
   creates first observation data including a carrier phase of the first positioning data and creates second observation data including a carrier phase of the second positioning data, and
   acquires a relative relationship between the first positioning data and the second positioning data for each positioning satellite in time-series using the first observation data, the second observation data, and the satellite orbit data, and calculates a position of the moving body based on the acquired relative relationship and a position of the fixed point, the first observation data and the second observation data including a pseudo range to the positioning satellite and a carrier phase, respectively.

### (Supplementary Note 3)

The information processing apparatus according to claim 1,
wherein the first positioning data and the second positioning data for each of the positioning satellites are accumulated in time-series, and
the position calculation unit acquires the relative relationship for each of the positioning satellites in time-series using the first positioning data and the second positioning data for each of the positioning satellites that are accumulated, and calculates the position of the moving body based on the acquired relative relationship and the position of the fixed point.

### (Supplementary Note 4)

The information processing apparatus according to claim 3,
wherein the position calculation unit calculates the position of the moving body in a forward direction from past to future, a reverse direction from future to past, or bi-directionally in the forward direction and the reverse direction.

### (Supplementary Note 5)

The information processing apparatus according to claim 1,
wherein the time associated with the first positioning data is a transmission time of the first positioning data, and
the imaging position specification unit, based on a result of the collation, specifies the position corresponding to the imaging position of the frame by associating the corresponding first positioning data with the frame such that, for each frame, the imaging time and the transmission time of the first positioning data coincide with each other, or a difference between the imaging time and the transmission time of the first positioning data is within a set range.

### (Supplementary Note 6)

The information processing apparatus according to claim 1,
wherein the time associated with the first positioning data is a reception time of the first positioning data, and
the imaging position specification unit, based on a result of the collation, specifies the position corresponding to an imaging position of the frame by associating the corresponding first positioning data with the frame such that, for each frame, the imaging time and a reception time of the first positioning data coincide with each other, or a difference between the imaging time and the reception time of the first positioning data is within a set range.

### (Supplementary Note 7)

An information processing method includes:
a time information addition step of adding time information indicating an imaging time to each frame constituting moving image data;
a data acquisition step of acquiring, in time-series, first positioning data received by a moving body that captures the moving image data from each of a plurality of positioning satellites, and second positioning data received by a base station installed at a fixed point from each of the plurality of positioning satellites;
a position calculation step of calculating, in time-series, a position of the moving body, based on a relative relationship between the first positioning data and the second positioning data for each positioning satellite and a position of the fixed point at which the base station is installed;
an imaging position specification step of specifying, for each of the frames, collating the imaging time indicated by the time information added to the frame with a time associated with the first positioning data, and specifying a position corresponding to an imaging position of the frame from among positions of the moving body calculated in time-series; and
a position information addition step of adding, for each of the frames, information indicating the specified position to the frame.

### (Supplementary Note 8)

The information processing method according to claim 7,
wherein, in the data acquisition step, for each of the plurality of positioning satellites, satellite orbit data indicating a position of the positioning satellite for each time received by the base station from the positioning satellite is further acquired,
in the position calculation step,
   first observation data including a carrier phase of the first positioning data is created, and second observation data including a carrier phase of the second positioning data is created, and
   a relative relationship between the first positioning data and the second positioning data for each positioning satellite in time-series is acquired using the first observation data, the second observation data, and the satellite orbit data, and a position of the moving body is calculated based on the acquired relative relationship and a position of the fixed point, the first observation data and the second observation data including a pseudo range to the positioning satellite and a carrier phase, respectively.

### (Supplementary Note 9)

The information processing method according to claim 7,
wherein the first positioning data and the second positioning data for each of the positioning satellites are accumulated in time-series, and
   in the position calculation step, the relative relationship for each of the positioning satellites is acquired in time-series using the first positioning data and the second positioning data for each of the positioning satellites that are accumulated, and the position of the moving body is calculated based on the acquired relative relationship and the position of the fixed point.

### (Supplementary Note 10)

The information processing apparatus according to claim 9,
wherein, in the position calculation step, calculating the position of the moving body in a forward direction from past to future, a reverse direction from future to past, or bi-directionally in the forward direction and the reverse direction.

### (Supplementary Note 11)

The information processing method according to claim 7,
wherein the time associated with the first positioning data is a transmission time of the first positioning data, and
in the imaging position specification step, based on a result of the collation, the position corresponding to the imaging position of the frame is specified by associating the corresponding first positioning data with the frame such that, for each frame, the imaging time and the transmission time of the first positioning data coincide with each other, or a difference between the imaging time and the transmission time of the first positioning data is within a set range.

### (Supplementary Note 12)

The information processing method according to claim 7,
wherein the time associated with the first positioning data is a reception time of the first positioning data, and
in the imaging position specification step, based on a result of the collation, the position corresponding to an imaging position of the frame is specified by associating the corresponding first positioning data with the frame such that, for each frame, the imaging time and a reception time of the first positioning data coincide with each other, or a difference between the imaging time and the reception time of the first positioning data is within a set range.

### (Supplementary Note 13)

A computer readable recording medium that includes recorded thereon a program,
the program including instruction that cause a computer to carry out:
a time information addition step of adding time information indicating an imaging time to each frame constituting moving image data;
a data acquisition step of acquiring, in time-series, first positioning data received by a moving body that captures the moving image data from each of a plurality of positioning satellites, and second positioning data received by a base station installed at a fixed point from each of the plurality of positioning satellites;
a position calculation step of calculating, in time-series, a position of the moving body, based on a relative relationship between the first positioning data and the second positioning data for each positioning satellite and a position of the fixed point at which the base station is installed;
an imaging position specification step of specifying, for each of the frames, collating the imaging time indicated by the time information added to the frame with a time associated with the first positioning data, and specifying a position corresponding to an imaging position of the frame from among positions of the moving body calculated in time-series; and
a position information addition step of adding, for each of the frames, information indicating the specified position to the frame.

### (Supplementary Note 14)

The computer-readable recording medium according to claim 13,
wherein, in the data acquisition step, for each of the plurality of positioning satellites, satellite orbit data indicating a position of the positioning satellite for each time received by the base station from the positioning satellite is further acquired,
in the position calculation step,
   first observation data including a carrier phase of the first positioning data is created, and second observation data including a carrier phase of the second positioning data is created, and
   a relative relationship between the first positioning data and the second positioning data for each positioning satellite in time-series is acquired using the first observation data, the second observation data, and the satellite orbit data, and a position of the moving body is calculated based on the acquired relative relationship and a position of the fixed point, the first observation data and the second observation data including a pseudo range to the positioning satellite and a carrier phase, respectively.

### (Supplementary Note 15)

The computer-readable recording medium according to claim 13,
wherein the first positioning data and the second positioning data for each of the positioning satellites are accumulated in time-series, and
   in the position calculation step, the relative relationship for each of the positioning satellites is acquired in time-series using the first positioning data and the second positioning data for each of the positioning satellites that are accumulated, and the position of the moving body is calculated based on the acquired relative relationship and the position of the fixed point.

### (Supplementary Note 16)

The computer-readable recording medium according to claim 15,
wherein, in the position calculation step, calculating the position of the moving body in a forward direction from past to future, a reverse direction from future to past, or bi-directionally in the forward direction and the reverse direction.

### (Supplementary Note 17)

The computer-readable recording medium according to claim 13,
wherein the time associated with the first positioning data is a transmission time of the first positioning data, and
in the imaging position specification step, based on a result of the collation, the position corresponding to the imaging position of the frame is specified by associating the corresponding first positioning data with the frame such that, for each frame, the imaging time and the transmission time of the first positioning data coincide with each other, or a difference between the imaging time and the transmission time of the first positioning data is within a set range.

### (Supplementary Note 18)

The computer-readable recording medium according to claim 13,
wherein the time associated with the first positioning data is a reception time of the first positioning data, and
in the imaging position specification step, based on a result of the collation, the position corresponding to an imaging position of the frame is specified by associating the corresponding first positioning data with the frame such that, for each frame, the imaging time and a reception time of the first positioning data coincide with each other, or a difference between the imaging time and the reception time of the first positioning data is within a set range.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

This application is based upon and claims the benefit of priority from Japanese application No. 2022-198640 filed on Dec. 13, 2022, the disclosure of which is incorporated herein in its entirety by reference.

### INDUSTRIAL APPLICABILITY

As described above, according to the present disclosure, it is possible to improve accuracy of position information in a case where position information of an imaging position is added to moving image data. The present disclosure is useful for a system that generates 3D point cloud data of an object from moving image data.

### REFERENCE SIGNS LIST

10 Information processing apparatus
11 Time information addition unit
12 Data acquisition unit
13 Position calculation unit
14 Imaging position specification unit
15 Position information addition unit
20 Unmanned aerial vehicle (Moving body)
21 Moving body database
30 Base station
31 Base station database
40 Positioning satellite
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information processing apparatus comprising:
at least one memory storing instructions; and
at least one processor configured to execute the instructions to:
add time information indicating an imaging time to each frame constituting moving image data;
acquire, in time-series, first positioning data received by a moving body that captures the moving image data from each of a plurality of positioning satellites, and second positioning data received by a base station installed at a fixed point from each of the plurality of positioning satellites;
calculate, in time-series, a position of the moving body, based on a relative relationship between the first positioning data and the second positioning data for each positioning satellite and a position of the fixed point at which the base station is installed;
collate, for each of the frames, the imaging time indicated by the time information added to the frame with a time associated with the first positioning data, and specify a position corresponding to an imaging position of the frame from among positions of the moving body calculated in time-series; and
add, for each of the frames, information indicating the specified position to the frame.

2. The information processing apparatus according to claim 1, wherein
at least one processor
further acquires, for each of the plurality of positioning satellites, satellite orbit data indicating a position of the positioning satellite for each time received by the base station from the positioning satellite,
creates first observation data including a carrier phase of the first positioning data and creates second observation data including a carrier phase of the second positioning data, and
acquires a relative relationship between the first positioning data and the second positioning data for each positioning satellite in time-series using the first observation data, the second observation data, and the satellite orbit data, and calculates a position of the moving body based on the acquired relative relationship and a position of the fixed point, the first observation data and the second observation data including a pseudo range to the positioning satellite and a carrier phase, respectively.

3. The information processing apparatus according to claim 1,
wherein the first positioning data and the second positioning data for each of the positioning satellites are accumulated in time-series, and
at least one processor acquires the relative relationship for each of the positioning satellites in time-series using the first positioning data and the second positioning data for each of the positioning satellites that are accumulated, and calculates the position of the moving body based on the acquired relative relationship and the position of the fixed point.

4. The information processing apparatus according to claim 3,
at least one processor calculates the position of the moving body in a forward direction from past to future, a reverse direction from future to past, or bi-directionally in the forward direction and the reverse direction.

5. The information processing apparatus according to claim 1,
wherein the time associated with the first positioning data is a transmission time of the first positioning data, and
at least one processor, based on a result of the collation, specifies the position corresponding to the imaging position of the frame by associating the corresponding first positioning data with the frame such that, for each frame, the imaging time and the transmission time of the first positioning data coincide with each other, or a difference between the imaging time and the transmission time of the first positioning data is within a set range.

6. The information processing apparatus according to claim 1,
wherein the time associated with the first positioning data is a reception time of the first positioning data, and
at least one processor, based on a result of the collation, specifies the position corresponding to an imaging position of the frame by associating the corresponding first positioning data with the frame such that, for each frame, the imaging time and a reception time of the first positioning data coincide with each other, or a difference between the imaging time and the reception time of the first positioning data is within a set range.

7. An information processing method comprising:
adding time information indicating an imaging time to each frame constituting moving image data;
acquiring, in time-series, first positioning data received by a moving body that captures the moving image data from each of a plurality of positioning satellites, and second positioning data received by a base station installed at a fixed point from each of the plurality of positioning satellites;
calculating, in time-series, a position of the moving body, based on a relative relationship between the first positioning data and the second positioning data for each positioning satellite and a position of the fixed point at which the base station is installed;
specifying, for each of the frames, collating the imaging time indicated by the time information added to the frame with a time associated with the first positioning data, and specifying a position corresponding to an imaging position of the frame from among positions of the moving body calculated in time-series; and
adding, for each of the frames, information indicating the specified position to the frame.

8. The information processing method according to claim 7,
wherein, in the acquisition of the first positioning data and the second positioning data, for each of the plurality of positioning satellites, satellite orbit data indicating a position of the positioning satellite for each time received by the base station from the positioning satellite is further acquired,
in the position calculation,
first observation data including a carrier phase of the first positioning data is created, and second observation data including a carrier phase of the second positioning data is created, and
a relative relationship between the first positioning data and the second positioning data for each positioning satellite in time-series is acquired using the first observation data, the second observation data, and the satellite orbit data, and a position of the moving body is calculated based on the acquired relative relationship and a position of the fixed point, the first observation data and the second observation data including a pseudo range to the positioning satellite and a carrier phase, respectively.

9. The information processing method according to claim 7,
wherein the first positioning data and the second positioning data for each of the positioning satellites are accumulated in time-series, and
in the position calculation, the relative relationship for each of the positioning satellites is acquired in time-series using the first positioning data and the second positioning data for each of the positioning satellites that are accumulated, and the position of the moving body is calculated based on the acquired relative relationship and the position of the fixed point.

10. The information processing apparatus according to claim 9,
wherein, in the position calculation, calculating the position of the moving body in a forward direction from past to future, a reverse direction from future to past, or bi-directionally in the forward direction and the reverse direction.

11. The information processing method according to claim 7,
wherein the time associated with the first positioning data is a transmission time of the first positioning data, and
in the specification of the imaging position, based on a result of the collation, the position corresponding to the imaging position of the frame is specified by associating the corresponding first positioning data with the frame such that, for each frame, the imaging time and the transmission time of the first positioning data coincide with each other, or a difference between the imaging time and the transmission time of the first positioning data is within a set range.

12. The information processing method according to claim 7,
wherein the time associated with the first positioning data is a reception time of the first positioning data, and
in the specification of the imaging position, based on a result of the collation, the position corresponding to an imaging position of the frame is specified by associating the corresponding first positioning data with the frame such that, for each frame, the imaging time and a reception time of the first positioning data coincide with each other, or a difference between the imaging time and the reception time of the first positioning data is within a set range.

13. A non-transitory computer-readable recording medium that includes a program recorded thereon, the program including instructions that cause a computer to perform:
adding time information indicating an imaging time to each frame constituting moving image data;
acquiring, in time-series, first positioning data received by a moving body that captures the moving image data from each of a plurality of positioning satellites, and second positioning data received by a base station installed at a fixed point from each of the plurality of positioning satellites;
calculating, in time-series, a position of the moving body, based on a relative relationship between the first positioning data and the second positioning data for each positioning satellite and a position of the fixed point at which the base station is installed;
specifying, for each of the frames, collating the imaging time indicated by the time information added to the frame with a time associated with the first positioning data, and specifying a position corresponding to an imaging position of the frame from among positions of the moving body calculated in time-series; and
adding, for each of the frames, information indicating the specified position to the frame.

14. The non-transitory computer-readable recording medium according to claim 13,
wherein, in the acquisition of the first positioning data and the second positioning data, for each of the plurality of positioning satellites, satellite orbit data indicating a position of the positioning satellite for each time received by the base station from the positioning satellite is further acquired,
in the position calculation,
first observation data including a carrier phase of the first positioning data is created, and second observation data including a carrier phase of the second positioning data is created, and
a relative relationship between the first positioning data and the second positioning data for each positioning satellite in time-series is acquired using the first observation data, the second observation data, and the satellite orbit data, and a position of the moving body is calculated based on the acquired relative relationship and a position of the fixed point, the first observation data and the second observation data including a pseudo range to the positioning satellite and a carrier phase, respectively.

15. The non-transitory computer-readable recording medium according to claim 13,
wherein the first positioning data and the second positioning data for each of the positioning satellites are accumulated in time-series, and
in the position calculation, the relative relationship for each of the positioning satellites is acquired in time-series using the first positioning data and the second positioning data for each of the positioning satellites that are accumulated, and the position of the moving body is calculated based on the acquired relative relationship and the position of the fixed point.

16. The non-transitory computer-readable recording medium according to claim 15,
wherein, in the position calculation, calculating the position of the moving body in a forward direction from past to future, a reverse direction from future to past, or bi-directionally in the forward direction and the reverse direction.

17. The non-transitory computer-readable recording medium according to claim 13,
wherein the time associated with the first positioning data is a transmission time of the first positioning data, and
in the specification of the imaging position, based on a result of the collation, the position corresponding to the imaging position of the frame is specified by associating the corresponding first positioning data with the frame such that, for each frame, the imaging time and the transmission time of the first positioning data coincide with each other, or a difference between the imaging time and the transmission time of the first positioning data is within a set range.

18. The non-transitory computer-readable recording medium according to claim 13,
wherein the time associated with the first positioning data is a reception time of the first positioning data, and
in the specification of the imaging position, based on a result of the collation, the position corresponding to an imaging position of the frame is specified by associating the corresponding first positioning data with the frame such that, for each frame, the imaging time and a reception time of the first positioning data coincide with each other, or a difference between the imaging time and the reception time of the first positioning data is within a set range.
